(19) United States
(12) Patent Application Publication
(10) Pub. No.: US 2018/0067987 A1
(43) Pub. Date: Mar. 8, 2018

(54) DATABASE CAPABLE OF INTEGRATED QUERY PROCESSING AND DATA PROCESSING METHOD THEREOF

(71) Applicant: Bitnine Co., Ltd., Seoul (KR)

(72) Inventors: Choelsun KANG, Incheon (KR); Kisung KIM, Seoul (KR); Junseok YANG, Jeonju-si (KR); Hyeongtae LIM, Incheon (KR); Gitae YUN, Seoul (KR)

(21) Appl. No.: 15/697,669

(22) Filed: Sep. 7, 2017

(30) Foreign Application Priority Data
Sep. 7, 2016 (KR) 10-2016-0115196

(51) Int. Cl. G06F 17/30

(52) U.S. Cl. CPC G06F 17/30427; G06F 17/30339; G06F 17/30442; G06F 17/30415

(57) ABSTRACT

The present invention provides a database capable of integrated query processing and a data processing method thereof. The database capable of integrated query processing includes: a storage unit configured to store data including relational data, and graph data; a converter configured to convert a query language for a property graph data model for processing the graph data into a relational algebra that is a statement in an intermediate stage; and a controller configured to control the converter so as to convert the query language for the property graph data model in an input integrated query into a syntactic statement structure, and convert the query language for the property graph data model included in the query into the relational algebra, when the integrated query, in which the query language for the property graph data model and the relational query language are mixed, is input.

### RELATED APPLICATIONS

This application claims priority to Korean Patent Application No. 10-2016-0115196, filed on Sep. 7, 2016 in the Korean Intellectual Property Office, the entire disclosure of which is incorporated herein by reference.

### BACKGROUND OF THE INVENTION

### 1. Field of the Invention

The present invention relates to a database capable of integrated query processing and a data processing method thereof, and more particularly, to a database capable of integrated query processing for relational data and graph data by receiving an input of a graph query language in a relational database, and a data processing method thereof.

### 2. Description of the Related Art

A data processing apparatus stores and processes input data, and outputs a result corresponding to a query input by a user. Particularly, when a capacity of the input data is large, various types of databases are used to increase a processing rate and obtain reliable results.

Among these databases, a graph database is optimized to process semi-structured data that do not observe a structured data model rule connected to a relational database or a different type of data table, thereby being applied to various fields such as social data, recommendation, geographic spatial analysis and the like.

In a case of a relational data model used for the relational database, in order to define a schema, it is necessary to generate a table for describing entity information, and separately create a table for storing information on connection between entities.

Further, in the case of the relational data model, it is necessary to describe a join operation for these tables and describe conditions of each join to define a query, and when the schema is complicated, the query becomes complicated, and the join operation may be increased.

As compared thereto, a graph data model used for the above-described graph database has advantages of being able to intuitively express real-life data by a form of a graph data structure without using a table, and simply create queries without requiring a fixed schema.

However, the above-described relational database and the graph database are basically different from each other in terms of a structure and a unit used to store data, and thus a query language is also different. As a result, it is difficult to change a relational database into a graph database or convert the query language, such that it is difficult to simultaneously process a relational query language and a graph query language in one database.

As a relevant prior art, Korean Patent Laid-Open Publication No. 10-2004-63998 discloses a method and a device for presenting, managing and exploiting graphical queries in data management systems, however, did not solve the above-described problems.

### SUMMARY OF THE INVENTION

Accordingly, it is an object of the present invention to provide a database capable of integrated query processing in which a relational query language and a graph query language may be simultaneously processed in one database, and a data processing method thereof.

In addition, another object of the present invention is to provide a database capable of integrated query processing for improving query processing performance by performing a general query processing optimization method regardless of a relational query language and a graph query language, and a data processing method thereof.

In order to achieve the above objects, there is provided a database capable of integrated query processing, including: a storage unit configured to store data including relational data stored in a table form according to a schema of a relational database, and graph data stored in a form of four entities including a node, an edge, and properties for the node and the edge; a converter configured to convert a query language for a property graph data model for processing the graph data into a relational algebra that is a statement in an intermediate stage for processing a relational query language by a subquery connection method in a pipeline form; and a controller configured to control the converter so as to convert the query language for the property graph data model in an input integrated query into a syntactic statement structure, and convert the query language for the property graph data model included in the query into the relational algebra, when the integrated query, in which the query language for the property graph data model and the relational query language are mixed, is input.

The converter may include: a parser configured to convert the query language for the property graph data model into the syntactic statement structure; and a plan creator configured to create a lowest-cost plan for the query result from the structure converted by the parser.

The plan creator may include: a logical plan creator configured to map the query language for the property graph data model to the relational algebra and add an operator for the query language for the property graph data model; and a physical plan creator configured to create the lowest-cost plan among a plurality of plans resulting in equivalent results for the relational algebra.

Meanwhile, according to another aspect of the present invention, there is provided a data processing method of a database capable of integrated query processing, the method comprising the steps of: storing, by a controller, data including relational data stored in a table form according to a schema of a relational database, and graph data stored in a form of four entities including a node, an edge, and properties for the node and the edge in a storage unit; receiving, by the controller, an integrated query in which a query language for a property graph data model and a relational query language are mixed; and converting, by the controller, the query language for the property graph data model in the input query into a syntactic statement structure, and converting the query language for the property graph data model included in the query into a relational algebra that is a statement in an intermediate stage for processing the relational query language by a subquery connection method in a pipeline form, when the query is input.

The step of converting the query language for the property graph data model into the relational algebra further may include: a step of converting the input query language for the property graph data model into the syntactic statement structure; and a step of creating a lowest-cost plan for a query result from the converted structure.

The step of creating the plan from the converted structure further may include: a logical plan creating step of mapping the query language for the property graph data model to the relational algebra, and adding an operator for the query language for the property graph data model; and a physical plan creating step of creating the lowest-cost plan among a plurality of plans resulting in equivalent results for the relational algebra.

In accordance with the database capable of integrated query processing and the data processing method thereof according to the present invention, the relational query language and the graph query language may be simultaneously processed in one database.

Further, in accordance with the database capable of integrated query processing and the data processing method thereof according to the present invention, query processing performance may be improved by performing a general query processing optimization method regardless of the relational query language and the graph query language.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a configuration of a database according to an embodiment of the present invention;

FIG. 2 is a diagram illustrating an integrated query used in the database according to the embodiment of the present invention;

FIG. 3 is a diagram for describing a process of converting a graph query language into a relational query language for processing relational data in the database according to the embodiment of the present invention;

FIGS. 4A and 4B are diagrams for describing a process of creating a logical plan in the database according to the embodiment of the present invention;

FIG. 5 is a diagram for describing a process for recognizing each statement of a graph query language in a subquery form in the database according to the embodiment of the present invention; and

FIG. 6 is a flowchart illustrating a data processing method of the database according to the embodiment of the present invention.

### DETAILED DESCRIPTION OF THE INVENTION

Hereinafter, a database capable of integrated query processing and a data processing method thereof according to the present invention will be described in detail with reference to the accompanying drawings.

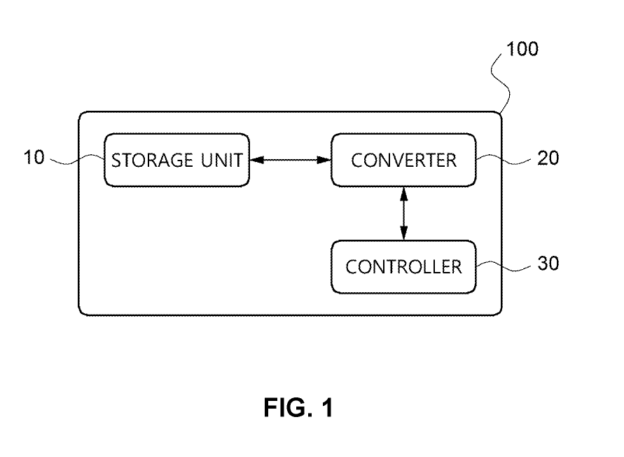

FIG. 1 is a block diagram illustrating a configuration of a database according to an embodiment of the present invention. As illustrated in FIG. 1, the database according to the embodiment of the present invention includes a storage unit 10, a converter 20, and a controller 30.

The storage unit 10 is configured to store relational data and graph data. The relational data are stored in the storage unit 10 in a table form according to a schema of a relational database management system (RDBMS) known in the related art, and in a case of the graph data, four entities including a node, an edge, and properties for the node and the edge are stored in the storage unit 10. Herein, the relational data are stored in the storage unit 10 in a block structure with a fixed size, while the graph data may be stored in the storage unit 10 in a variable structure for storing data depending on a type thereof.

The converter 20 is configured to convert a graph query language for processing the graph data into a relational algebra that is a statement in an intermediate stage for processing a relational query language by a subquery connection method in a pipeline form, by a control of the controller 30.

Specifically, the converter 20 converts the relational query language into a relational algebra which is a mathematical operation, and also converts the graph query language into a relational algebra similarly to the relational query language. Accordingly, it is possible to create an integrated query by embedding the graph query language into the relational query language in a subquery form to mix the relational query language and the graph query language that are syntactically different from each other.

Herein, the relational query language according to the embodiment of the present invention may include a structured query language (SQL), and the graph query language may include a query language for a property graph data model. The property graph data model has a characteristic that can define a pair of a key and a value thereof (<key and value> pair) for a node and an edge included in the graph data. As a representative example of the query language of the property graph data model, there is a cypher.

Meanwhile, the storage unit 10 according to the present invention may use a node, an edge, and a path which is an array of the node and the edge as a column of a table in order to store the graph data in the relational database.

When the graph query language is input, the controller 30 is configured to control the converter 20 so as to convert the input graph query language into a relational algebra that is a statement in the intermediate stage for processing the relational query language. The controller 30 according to the present invention may be implemented by a microcomputer and software for driving the microcomputer, software that may be embedded in the database or the like.

Thereby, the database capable of integrated query processing according to the present invention may perform the integrated query processing using an existing relational query processing engine without a separate module for processing the graph query language.

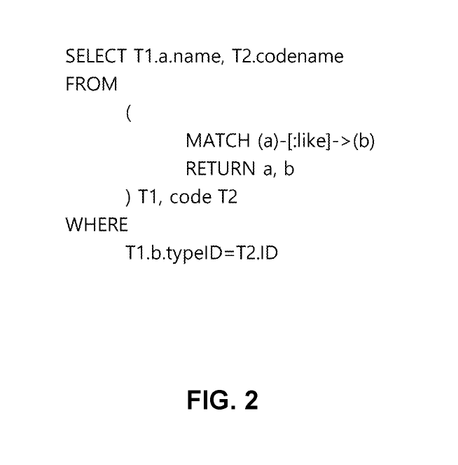

FIG. 2 is a diagram illustrating the integrated query used in the database according to the embodiment of the present invention.

As illustrated in FIG. 2, in the integrated query used in the database according to the present invention, the relational query language and the graph query language are mixed to be simultaneously used.

Herein, since a query result of MATCH (a)-[:like]->(b) is a relational table, the graph query language may be used in a form of subquery in a FROM statement that may refer to the table in the relational query language such as an SQL.

As in FIG. 2, the statement of the graph query language may be used in the relational query language as it is to return a result of processing the MATCH, and in addition, the result of processing the MATCH may be used in a CREATE clause like a query language of MATCH->CREATE, and query processing in a form, in which query processing such as READ referring to the table and data manipulation such as data insertion (INSERT) are mixed, may also be possible.

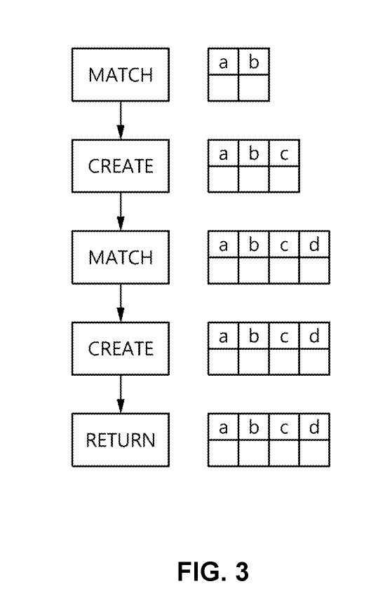

FIG. 3 is a diagram for describing a process of converting the graph query language into a relational query language for processing relational data in the database according to the embodiment of the present invention.

Generally, the graph query language includes a statement for executing various operations as an element. For example, “RETURN” defines a final query result, and “MATCH” searches a result matching a given pattern. Further, “OPTIONAL MATCH” executes an operation having a function similar to “outer join” of the SQL that is a relational query language. The graph query language may be used by connecting such a plurality of statements in a chain form in one query.

The statements of the graph query language connected as described above are adapted to transmit data in a pipeline form, and perform query processing in such a manner that each statement reads the input data of a previous statement to perform a specified work and then transmit the data to a next statement. In this case, the type or the number of result data is determined depending on the works defined in the statement.

Next, the above process will be described in detail with reference to FIG. 3. FIG. 3 illustrates a graph query including five statements, in which an operation result of MATCH (a)-[ ]->(b) is transmitted to CREATE (a)-[ ]->(c) which is a next statement, a result thereof is transmitted to MATCH (b)<-[ ]-(d), a result thereof is reflected in CREATE (c)-[ ]->(d), and then, names of a, b, c and d may be searched.

Herein, the converter 20 according to the present invention may include a parser 21 configured to convert the input query language into a syntactic statement structure, and a plan creator 22 configured to create a lowest-cost plan for the query result from the structure converted by the parser 21.

The parser 21 may recognize a new data type by addition of a keyword so as to recognize syntax of the graph query language, and converts a query language including the graph query language into one syntactic statement structure.

The plan creator 22 creates the lowest-cost plan for the query result from the structure converted by the parser 21. Hereinafter, a process of creating the plan by the plan creator 22 will be described.

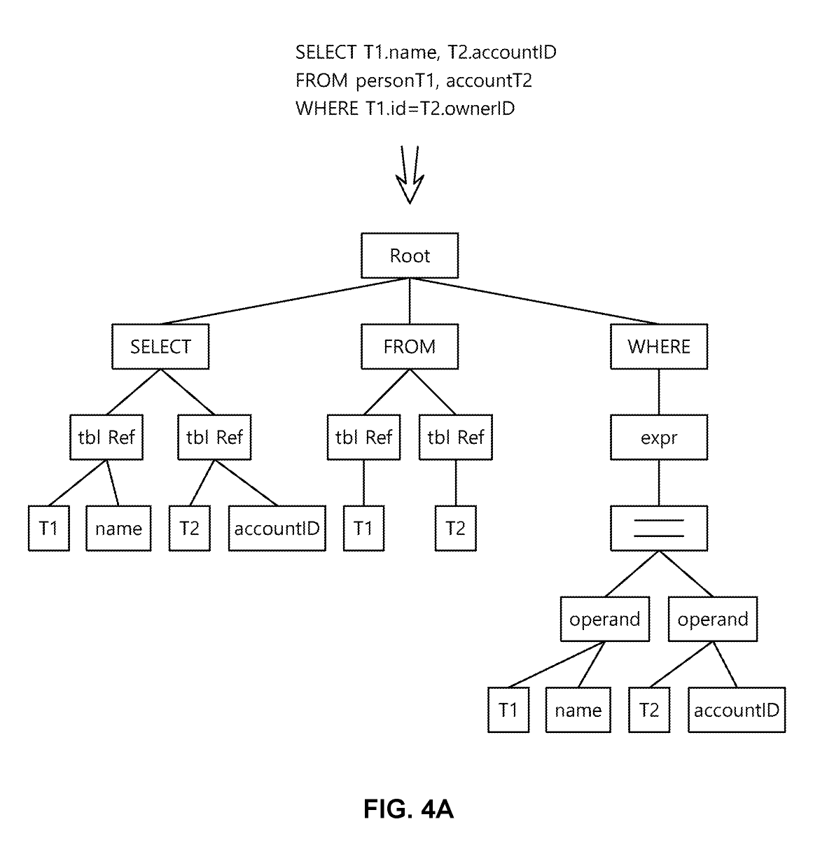

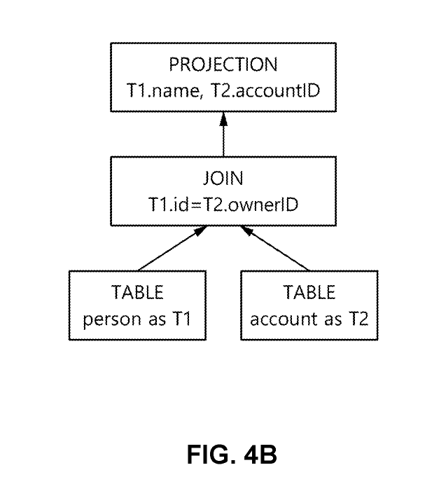

FIGS. 4A and 4B are diagrams for describing a process of creating, by the plan creator 22, a plan in the database according to the embodiment of the present invention. As illustrated in FIGS. 4A and 4B, the database according to the present invention creates a statement in an intermediate form for query optimization from a structure obtained by syntactically analyzing the graph query language. Specifically, the plan creator 22 according to the present invention creates a plan in a relational algebra form, and according to the plan, checks whether a table or a column to be referred to actually exists, whether permission to process data is given, or the like. The above plan may be considered as a logical plan for the integrated query processing.

Subsequently, the operation of the plan creator 22 according to the present invention will be described in detail with reference to FIG. 4A. First, the plan creator 22 divides the corresponding query into SELECT, FROM, and WHERE by syntactically analyzing the corresponding query, and checks whether tables T1 and T2 and columns of name and accountID of the table exist, and whether permission to process data is given.

Then, the plan creator 22 creates a plurality of plans that may generate equivalent processing results by different orders or different methods for the created relational algebra, and selects plans among the plurality of plans through cost prediction for determining that the created respective plans are executed by any algorithm among various algorithms such as JOIN, SORT or the like. Thereby, the lowest-cost plan among the multiple plans having equivalent results is selected, which may be considered as a physical plan for the integrated query processing.

That is, as illustrated in FIG. 4B, a plan in which after syntactical analysis, a join operation (JOIN) is performed to search a name of T1 and accountID of T2 that satisfy a condition that id of T1 is consistent with ownerID of T2 is selected as the lowest-cost plan to perform the join operation for T1 and T2.

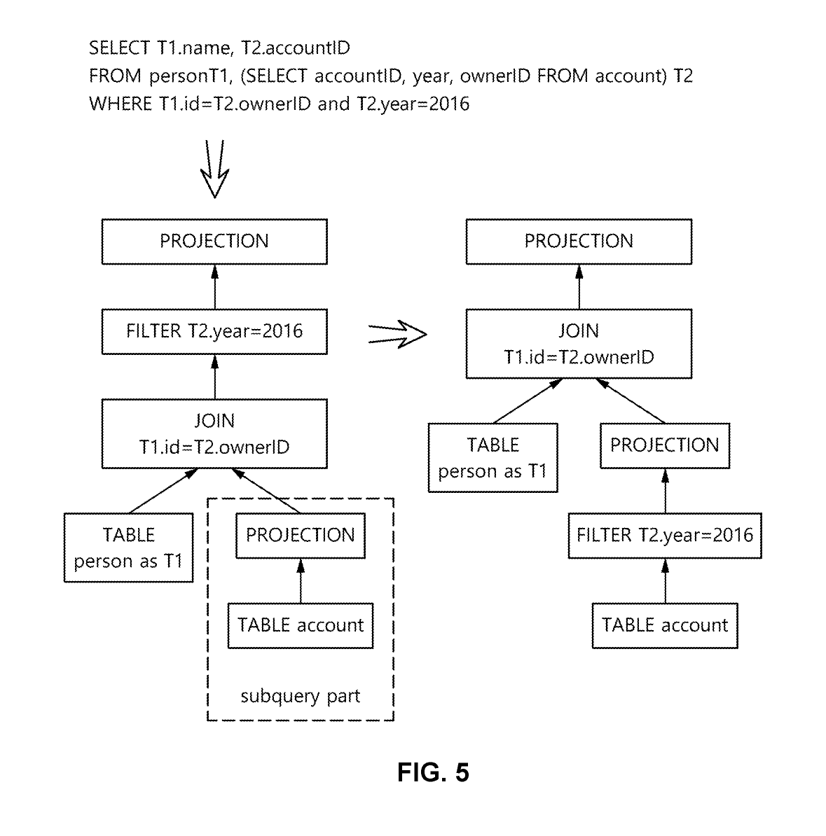

Meanwhile, if there is a subquery to overlap another query in one query, the plan creator 22 according to the present invention may create a plan by overlapping another logical plan in the logical plan, and additionally perform a process of making the plan as another logical plan. FIG. 5 is a diagram illustrating a process of performing, by the database according to the present invention, query processing using a subquery in FROM clause. As illustrated in FIG. 5, for the above-described graph query processing, the graph query language may be mapped to a relational algebra, a logical plan of adding an operator for the graph query language may be created, and in the created logical plan, a filter may perform push down to the subquery, thereby creating a more efficient logical plan.

Describing in detail with reference to FIG. 5, in order to search the name of T1 and accountID of T2 that satisfy the condition that the id of T1 is consistent with the ownerID of T2 and a condition that a year of T2 is 2016, data filtering for the condition that the year of T2 is 2016 is performed before performing the join operation, and data filtering for the condition that the year of T2 is 2016 is performed in an account table as well, thereby creating a more efficient plan.

As described above, the database according to the present invention mixes the graph query language having a characteristic that multiple statements may be used by being connected in a pipeline form with the relational query, such that a query may be easily created and performance of query processing may be improved.

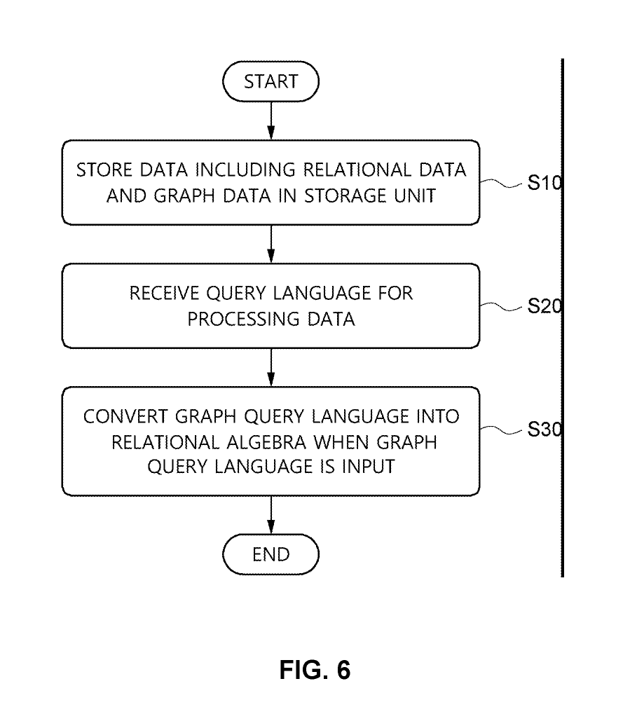

FIG. 6 is a flowchart illustrating a data processing method of the database capable of integrated query processing according to the embodiment of the present invention.

First, the controller 30 stores data including relational data and graph data in the storage unit 10 (S10). As described above, the relational data are stored in the storage unit 10 in a table form according to a schema of the relational database, and in the case of the graph data, four entities including a node, an edge, and properties for the node and the edge are stored in the storage unit 10.

Next, the controller 20 receives a query language for processing the data (S20).

Thereby, if the graph query language is included in the relational query statement, the controller 30 converts the graph query language into a relational algebra by the converter 20 by the subquery connection method in a pipeline form (S30).

Herein, step S30 may further include a step of converting the graph query language into a syntactic statement structure, and a step of creating a lowest-cost plan for the query result from the converted structure.

Further, the step of creating the plan from the converted structure may further include a logical plan creating step of mapping the graph query language to the relational algebra and adding an operation for the graph query language, and a physical plan creating step of creating a lowest-cost plan among a plurality of plans resulting in equivalent results for the relational algebra.

That is, in the data processing method of the database according to the present invention, the graph query language is converted into the relational algebra that is a statement in an intermediate stage for processing the relational query language, such that the graph query language may be mixed in the relational query statement to be simultaneously used, thereby describing the relational query language and the graph query language as one query. Thereby, the database according to the present invention may allow a general query processing optimization method to be performed regardless of the relational query language and the graph query language while integrally using the relational query language and the graph query language in one database.

Although the present invention has been described with reference to the embodiments shown in the drawings, but these are merely an example. It should be understood by persons having common knowledge in the technical field to which the present invention pertains that various modifications and modifications of the embodiments may be made. And, such modifications are included in the technical protection scope of the present invention. Accordingly, the real technical protection scope of the present invention is determined by the technical spirit of the appended claims.

### DESCRIPTION OF REFERENCE NUMERALS

10: storage unit

20: converter

30: controller

What is claimed is:

1. A database capable of integrated query processing, comprising: a storage unit configured to store data including relational data stored in a table form according to a schema of a relational database, and graph data stored in a form of four entities including a node, an edge, and properties for the node and the edge;
a converter configured to convert a query language for a property graph data model for processing the graph data into a relational algebra that is a statement in an intermediate stage for processing a relational query language by a subquery connection method in a pipeline form; and
a controller configured to control the converter so as to convert the query language for the property graph data model in an input integrated query into a syntactic statement structure, and convert the query language for the property graph data model included in the query into the relational algebra, when the integrated query, in which the query language for the property graph data model and the relational query language are mixed, is input.

2. The database of claim 1, wherein the converter comprises:
a parser configured to convert the query language for the property graph data model into the syntactic statement structure; and
a plan creator configured to create a lowest-cost plan for the query result from the structure converted by the parser.

3. The database of claim 2, wherein the plan creator comprises:
a logical plan creator configured to map the query language for the property graph data model to the relational algebra and add an operator for the query language for the property graph data model; and
a physical plan creator configured to create the lowest-cost plan among a plurality of plans resulting in equivalent results for the relational algebra.

4. A data processing method of a database capable of integrated query processing, the method comprising the steps of:
storing, by a controller, data including relational data stored in a table form according to a schema of a relational database, and graph data stored in a form of four entities including a node, an edge, and properties for the node and the edge in a storage unit;
receiving, by the controller, an integrated query in which a query language for a property graph data model and a relational query language are mixed; and
converting, by the controller, the query language for the property graph data model in the input query into a syntactic statement structure, and converting the query language for the property graph data model included in the query into a relational algebra that is a statement in an intermediate stage for processing the relational query language by a subquery connection method in a pipeline form, when the query is input.

5. The method of claim 4, wherein the step of converting the query language for the property graph data model into the relational algebra further comprises:
a step of converting the input query language for the property graph data model into the syntactic statement structure; and
a step of creating a lowest-cost plan for a query result from the converted structure.

6. The method of claim 5, wherein the step of creating the plan from the converted structure further comprises:
a logical plan creating step of mapping the query language for the property graph data model to the relational algebra, and adding an operator for the query language for the property graph data model; and
a physical plan creating step of creating the lowest-cost plan among a plurality of plans resulting in equivalent results for the relational algebra.
